(19) United States
(12) Patent Application Publication
(10) Pub. No.: US 2014/0344259 A1
(43) Pub. Date: Nov. 20, 2014

(54) ANSWERING PEOPLE-RELATED QUESTIONS

(71) Applicant: Google Inc., Mountain View, CA (US)

(72) Inventors: Bryan Christopher HORLING, Sunnyvale, CA (US); Okan KOLAK, Sunnyvale, CA (US); Vinh Quoc LY, Mountain View, CA (US); Toni Maximilian RATH, Mountain View, CA (US); Albert Lucas SEGARS, Berkeley, CA (US)

(21) Appl. No.: 13/915,354

(22) Filed: Jun. 11, 2013

Related U.S. Application Data
(60) Provisional application No. 61/823,568, filed on May 15, 2013.

(51) Int. Cl. G06F 17/30

(52) U.S. Cl. CPC G06F 17/3053
USPC 707/723

(57) ABSTRACT

A computer device may receive a search query from a user of a user device, determine that the search query is a people-related question, and identify, using a data structure, a set of people related to the search query, where the data structure is associated with the user, and where the data structure stores people-related data for a group of people with which the user is associated. The computer device may also determine whether to provide information relating to the set of people, and selectively provide, to the user device, one of a first document or a second document. The first document identifies at least one person in the set of people and provides information relating to the at least one person, where the information, relating to the at least one person, provides an answer to the people-related question. The second document excludes information relating to the set of people.

### RELATED APPLICATION

This application claims priority to U.S. Provisional Patent Application No. 61/823,568, filed May 15, 2013, the disclosure of which is incorporated by reference herein in its entirety.

### BACKGROUND

Many techniques are available to a user today to find information on the World Wide Web, also referred to as the “web.” For example, web browsers and/or search engines may be used to find information of interest.

### SUMMARY

According to some possible implementations, a method includes receiving, by one or more computer devices, a search query from a user of a user device; determining, by the one or more computer devices, that the search query is a people-related question; and identifying, by the one or more computer devices, based on determining that the search query is the people-related question, and using a data structure, a set of people related to the search query. The data structure is associated with the user, and the data structure stores people-related data for a group of people with which the user is associated. The set of people is a subset of the group of people. The method further includes determining, by the one or more computer devices, whether to provide information relating to the set of people; and selectively providing, by the one or more computer devices, to the user device, and based on determining whether to provide the information relating to the set of people, one of a first document that identifies at least one person in the set of people and provides information relating to the at least one person, where the information, relating to the at least one person, providing an answer to the people-related question, or a second document that excludes the information relating to the set of people.

According to some possible implementations, the method further includes restructuring the search query to form a restructured search query, and where identifying the set of people include comparing information in the restructured search query to information in the data structure, and identifying the set of people based on the comparison.

According to some possible implementations, the set of people includes a first person and a second person, and where the method further includes generating a first score for the first person, generating a second score for the second person, and selecting the at least one person based on the first score and the second score.

According to some possible implementations, generating the first score is based on at least one of a user-specified category with which the first person is associated, a geographic distance between the user and the first person, an indication of how recently the user has interacted with the first person, an indication of a quantity of interactions the user has had with the first person, an authority score associated with the first person, or an indication of whether the data structure stores a photo of the first person.

According to some possible implementations, determining whether to provide information relating to the set of people includes generating a score for each person in the set of people, comparing a highest score, of the generated scores, to a threshold, and determining to provide the information relating to the set of people when the highest score equals or exceed the threshold.

According to some possible implementations, the method further includes performing a general search, and obtaining general search results based on performing the general search, and where determining whether to provide information relating to the set of people includes generating a score for each person in the set of people, and determining whether to provide the information relating to the set of people based on the generated scores and information relating to the general search results.

According to some possible implementations, a computer-readable medium stores instructions, the instructions including one or more instructions, which, when executed by a processor, cause the processor to receive a search query from a user of a user device; determine that the search query is a people-related question; identify, based on determining that the search query is the people-related question and using a data structure, a set of people related to the search query, where the data structure is associated with the user, and the data structure stores people-related data for a group of people with which the user is associated, where the set of people is a subset of the group of people; determine whether to provide information relating to the set of people; and selectively provide, to the user device and based on determining whether to provide the information relating to the set of people, one of a first document that identifies at least one person in the set of people and provides information relating to the at least one person, where the information, relating to the at least one person, provides an answer to the people-related question, or a second document that excludes the information relating to the set of people.

According to some possible implementations, the one or more instructions further cause the processor to restructure the search query to form a restructured search query, and where the one or more instructions to cause the processor to identify the set of people further cause the processor to compare information in the restructured search query to information in the data structure, and identify the set of people based on the comparison.

According to some possible implementations, the set of people include a first person and a second person, and where the one or more instructions further cause the processor to generate a first score for the first person, generate a second score for the second person, and select the at least one person based on the first score and the second score.

According to some possible implementations, the one or more instructions to cause the processor to generate the first score and to generate the second score include one or more instructions to cause the processor to generate the first score and to generate the second score based on at least one of user-specified categories with which the first person and the second person are associated, geographic distances between the user and each of the first person and the second person, indications of how recently the user has interacted with the first person and the second person, indications of a quantity of interactions the user has had with the first person and a quantity of interactions the user has had with the second person, authority scores associated with the first person and the second person, or indications of whether the data structure stores a photo of the first person and the second person.

According to some possible implementations, the one or more instructions to cause the processor to determine whether to provide information relating to the set of people include one or more instructions to cause the processor to generate a score for each person in the set of people, compare a highest score, of the generated scores, to a threshold, and determine to provide the information relating to the set of people when the highest score equals or exceed the threshold.

According to some possible implementations, the one or more instructions further cause the processor to perform a general search, and obtain general search results based on performing the general search, and where the one or more instructions to cause the processor to determine whether to provide information relating to the set of people include one or more instructions to cause the processor to generate a score for each person in the set of people, and determine whether to provide the information relating to the set of people based on the generated scores and information relating to the general search results.

According to some possible implementations, the one or more instructions to selectively provide the one of the first document or the second document include one or more instructions to provide the first document, where the first document includes an interactive element, and where the interactive element allows the user to obtain information relating to people, other than the at least one person, in the set of people, obtain a current location of the at least one person, obtain directions to the current location of the at least one person, obtain directions to an address associated with the at least one person, or communicate with the at least one person.

According to some possible implementations, the one or more instructions to selectively provide the one of the first document or the second document include one or more instructions to provide the first document, where the information relating to the at least one person includes information that is calculated based on information stored in the data structure.

According to some possible implementations, a system includes one or more devices to receive a search query from a user of a user device; determine that the search query is a people-related question; identify, based on determining that the search query is the people-related question and using a data structure, a set of people related to the search query, where the data structure is associated with the user, and the data structure stores people-related data for a group of people with which the user is associated, the set of people being a subset of the group of people; select at least one person from the set of people; determine whether to provide information relating to the at least one person; and selectively provide, to the user device and based on determining whether to provide the information relating to the at least one person, one of a first document that identifies the at least one person and provides the information relating to the at least one person, where the information, relating to the at least one person, providing an answer to the people-related question, or a second document that excludes the information relating to the at least one person.

According to some possible implementations, the one or more devices are further to obtain information relating to the group of people from a group of different network-based sources; and associate, in the data structure, the obtained information with information identifying the group of people.

According to some possible implementations, the group of different network-based sources includes one or more of a phone contacts document, an email account, a calendar, a social network, voice communication records, or a web site.

According to some possible implementations, the obtained information includes, for a person, of the group of people, at least one of a name of the person, a nickname of the person, a tag that identifies a category in which the user has classified the person, an address of the person, a phone number of the person, an email address of the person, a fax number of the person, a photo of the person, information identifying a school that the person is attending or attended, an occupation of the person, a birthday of the person, or a current location of the person.

According to some possible implementations, the set of people includes a first person and a second person, and where, when selecting the at least one person, the one or more devices are to generate a first score for the first person, generate a second score for the second person, and select the at least one person based on the first score and the second score.

According to some possible implementations, when generating the first score and the second score, the one or more devices are further to generate the first score and generate the second score based on one or more of user-specified categories with which the first person and the second person are associated, geographic distances between the user and each of the first person and the second person, indications of how recently the user has interacted with the first person and the second person, indications of a quantity of interaction the user has had with the first person and a quantity of interactions the user has had with the second person, authority scores associated with the first person and the second person, or indications of whether the data structure stores a photo of the first person and the second person.

According to some possible implementations, a system includes means for receiving a search query from a user of a user device; means for determining that the search query is a people-related question; means for identifying, based on determining that the search query is the people-related question and using a data structure, a set of people related to the search query, where the data structure is associated with the user, and the data structure stores people-related data for a group of people with which the user is associated, the set of people being a subset of the group of people; means for selecting at least one person from the set of people; means for determining whether to provide information relating to the at least one person; and means for selectively providing, to the user device and based on determining whether to provide the information relating to the at least one person, one of a first document that identifies the at least one person and provides the information relating to the at least one person, where the information, relating to the at least one person, provides an answer to the people-related question, or a second document that excludes the information relating to the at least one person.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

The accompanying drawings, which are incorporated in and constitute a part of this specification, illustrate some implementations described herein and, together with the description, explain these implementations. In the drawings:

FIGS. 1A-1C are diagrams illustrating an overview of some implementations described herein;

FIG. 2 is a diagram of an example environment in which systems and/or methods described herein may be implemented;

FIG. 3 is an example data structure that may store people-related data according to one or more implementations described herein;

FIG. 4 is a flowchart of an example process for generating a people-related data structure, according to one or more implementations described herein;

FIG. 5 is an example user interface that may be provided in connection with the process of FIG. 4;

FIG. 6 is a flowchart of an example process for answering a people-related question, according to one or more implementations described herein;

FIGS. 7A-7E are an example of the process described in connection with FIG. 6; and

FIG. 8 is an example of a generic computing device and a generic mobile computing device, which may be used with the techniques described here.

### DETAILED DESCRIPTION

The following detailed description refers to the accompanying drawings. The same reference numbers in different drawings may identify the same or similar elements.

Systems and/or methods, as described herein, may allow a user to obtain answers to questions relating to people that the user knows. For example, systems and/or methods, as described herein, may populate a data structure, such as an index, with information relating to the people that the user knows. The information may be obtained from a variety of sources, such as the user's phone contacts, the user's email contacts, the user's calendar, a social network to which the user belongs, etc. The information may include, for example, contact information, such as addresses, phone numbers, email addresses, etc., birthdays, information identifying occupations, information identifying schools that the people are attending or have attended, etc.

Systems and/or methods, as described herein, may receive a natural language, people-related question, from the user, such as “where does Jane live?” Systems and/or methods, as described herein, may form a search query based on the natural language, people-related question and use the index to obtain people-related data to answer the question. Thus, for the example question of “where does Jane live?,” systems and/or methods, as described herein, may identify people named Jane in the index, obtain home addresses for the identified people, and provide, to the user, addresses for one or more of the identified people. In this way, systems and/or a user may allow a user to easily obtain information relating to people that the user knows.

The term document, as used herein, is to be broadly interpreted to include any machine-readable and machine-storable work product. A document may include, for example, a website, an e-mail, a business listing, a file, a combination of files, one or more files with embedded links to other files, a news group posting, a blog, etc. In the context of the Internet, a common document is a web page. Documents often include textual information and may include embedded information, such as meta information, images, hyperlinks, etc., and/or embedded instructions, such as Javascript, etc.

For the described systems and methods, the user can control whether the programs or features collect user personal information (e.g., information about a user's social network, actions, activities, a user's preferences, or a user's current location), or the extent such information is collected or used. In addition, certain data may be treated in one or more ways before the data is stored or used, so that personally identifiable information is removed, encrypted, and/or otherwise protected for the user. Thus, the user may have control over how information about the user is collected and used by a server.

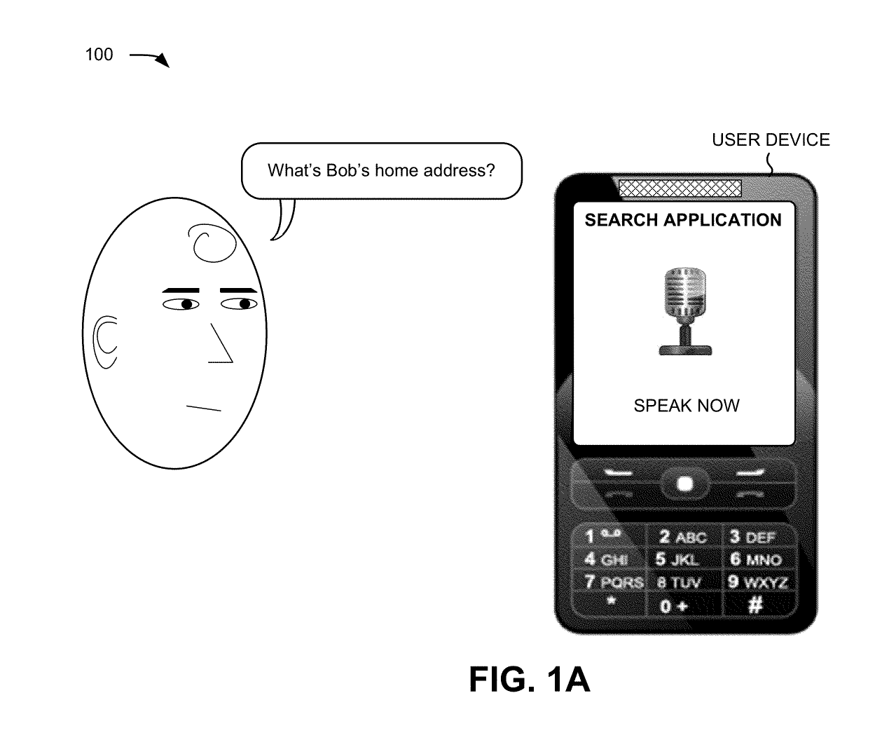

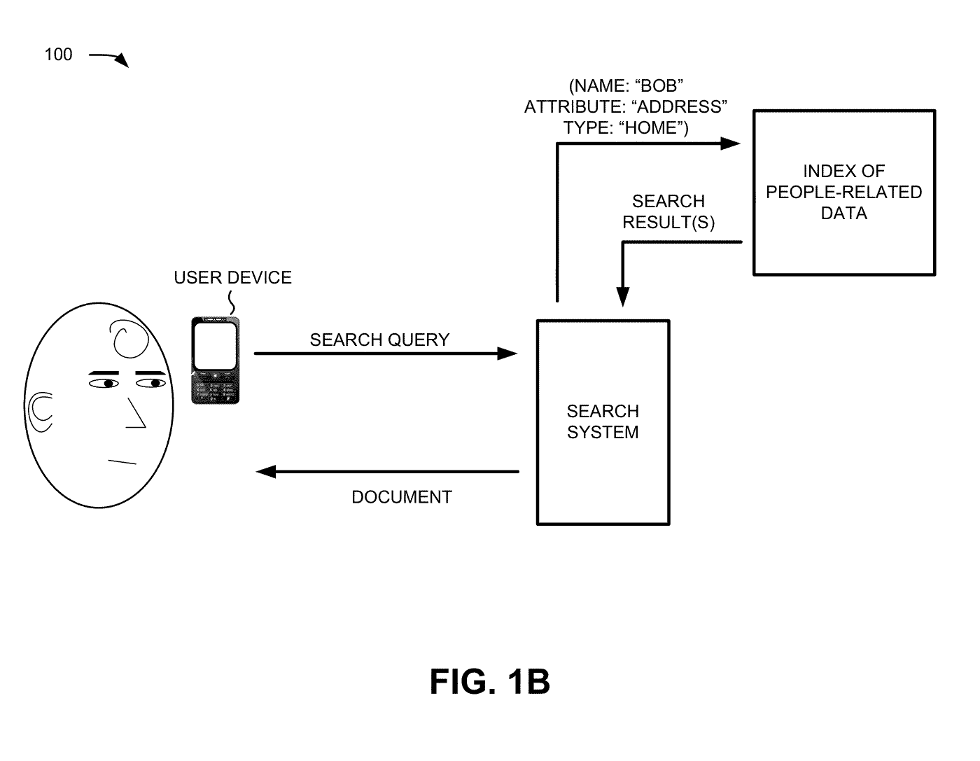

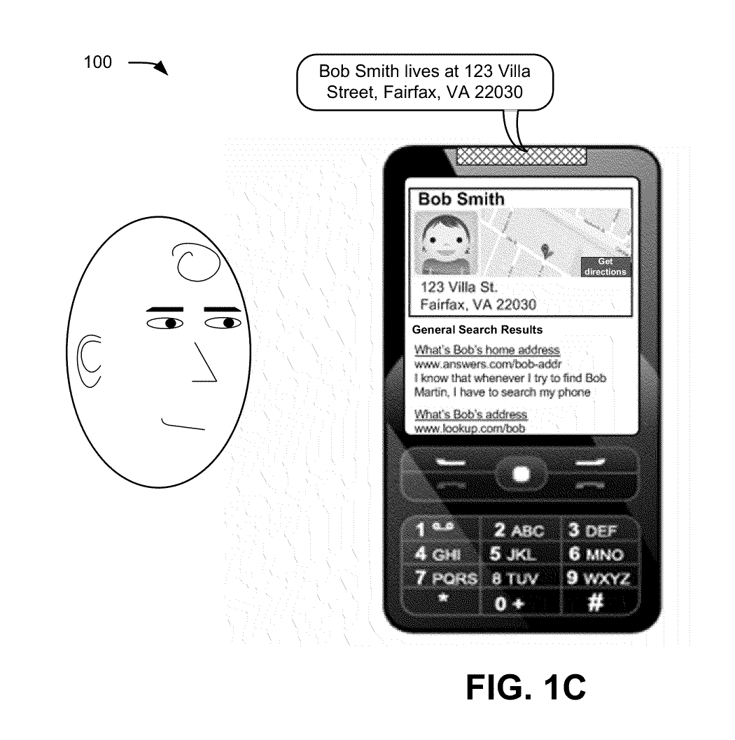

FIGS. 1A-1C are diagrams illustrating an overview 100 of some implementations described herein. For example 100, assume that a user is in the process of sending a birthday card to his friend, Bob. However, the user cannot remember Bob's home address. Thus, the user may initiate a search application on a user device. With reference to FIG. 1A, the user may audibly provide the question, “What's Bob's home address?” to the user device.

As shown in FIG. 1B, the user device may send the question to a search system, as a search query. The search system may determine that the search query relates to obtaining information relating to a person. Thus, the search system may form a structured query, shown as “NAME:‘BOB’ ATTRIBUTE:‘ADDRESS’ TYPE:‘HOME,’” based on the received search query. The search system may use an index, which includes people-related data, to identify people that the user knows named Bob and to obtain home addresses for those people. The search system may provide a document, including information identifying one or more of the identified people and their home address, to the user, as shown in FIG. 1C. In this way, the user may easily obtain the desired home address of his friend, Bob.

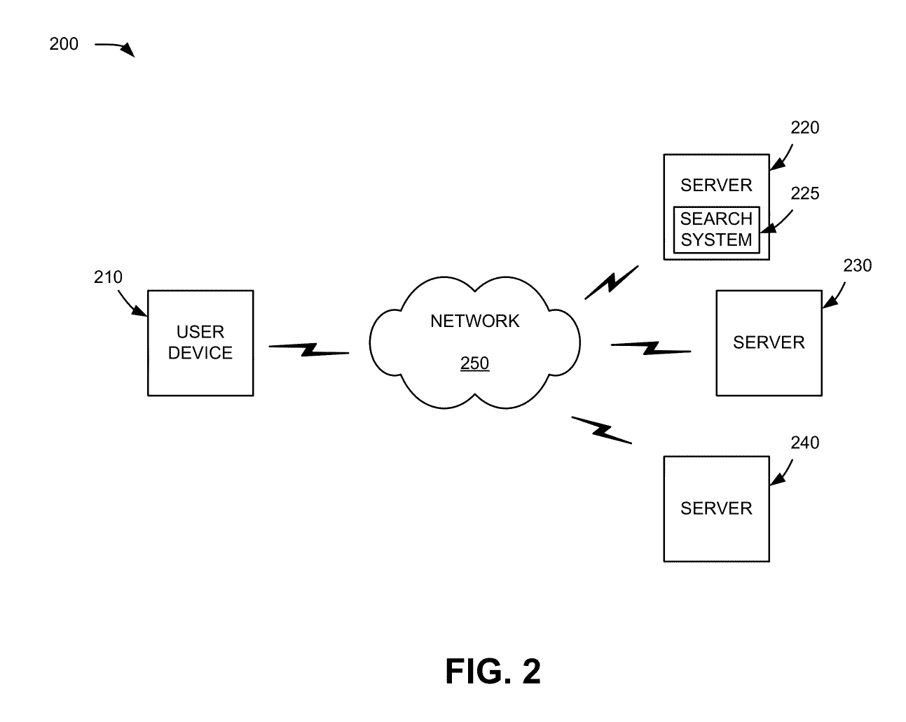

FIG. 2 is a diagram of an example environment 200 in which systems and/or methods described herein may be implemented. Environment 200 may include a user device 210 connected to multiple servers 220-240 via a network 250.

User device 210 may include a device capable of interacting with server 220 to perform a search. Examples of user device 210 may include a personal computer, a laptop computer, a tablet computer, a personal digital assistant, a mobile telephone, such as a smart phone, etc. User device 210 may include user interfaces presented through one or more browsers, e.g., web browsers.

Servers 220-240 may include server devices that gather, process, search, and/or implement functions in a manner described herein. Each server 220-240 may be implemented as a single server device or a collection of server devices that may be co-located or remotely located. Additionally, or alternatively, any two or more of servers 220-240 may be implemented within a single, common server device or a single, common collection of server devices. While servers 220-240 are shown as separate components, it may be possible for one or more of servers 220-240 to perform one or more of the functions of another one or more of servers 220-240.

As shown in FIG. 2, server 220 may implement a search system 225 that receives search queries from user device 210, and that provides search results that are responsive to the search queries. Server 220 may crawl a corpus of documents, e.g., web pages, index the documents, and store information associated with the documents. Servers 230 and 240 may store or maintain documents, including documents that may include people-related data, that may be crawled or analyzed by server 220.

Network 250 may include any type of network, such as, for example, a local area network, also referred to as a “LAN,” a wide area network, also referred to as a “WAN,” a telephone network, such as the Public Switched Telephone Network or a cellular network, an intranet, the Internet, a combination of networks, etc. User device 210 and servers 220-240 may connect to network 250 via wired and/or wireless connections. In other words, any one of user device 210 and servers 220-240 may connect to network 250 via a wired connection, a wireless connection, or a combination of a wired connection and a wireless connection.

Although FIG. 2 shows example components of environment 200, in some implementations, environment 200 may include additional components, fewer components, different components, and/or differently arranged components than those depicted in FIG. 2. Additionally, or alternatively, one or more components of environment 200 may perform one or more tasks described as being performed by one or more other components of environment 200.

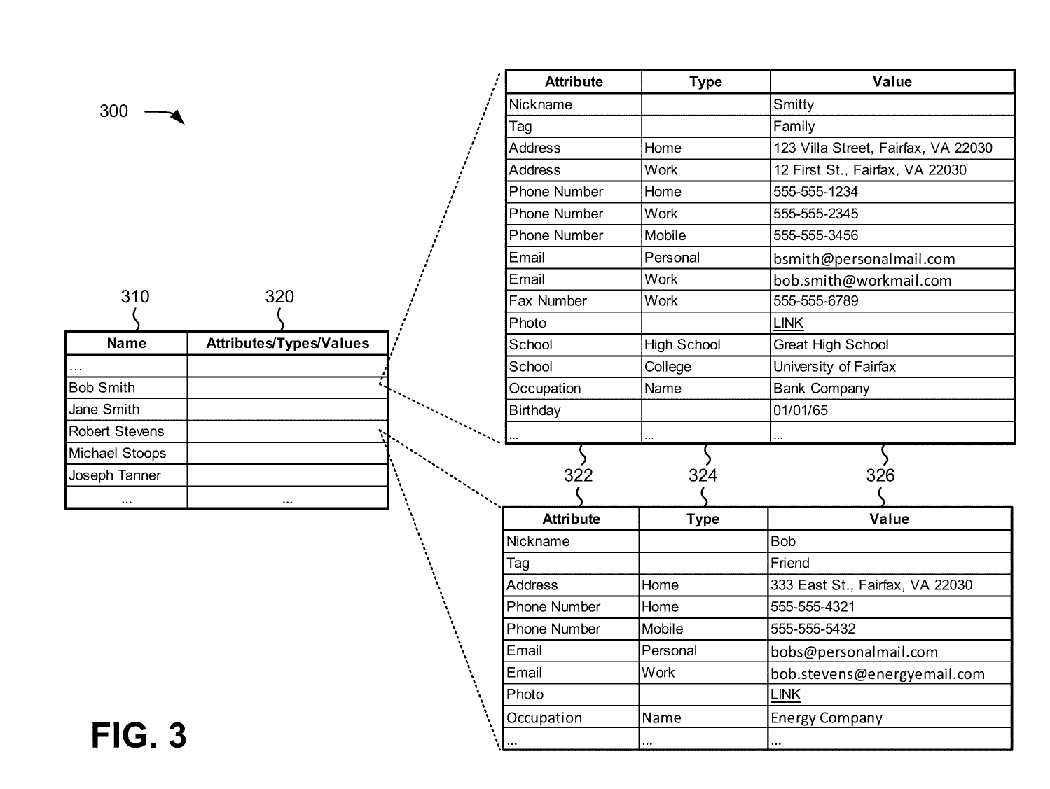

FIG. 3 is an example data structure 300 that may store people-related data according to one or more implementations described herein. In some implementations, data structure 300 may take the form of an index. Data structure 300 may be stored in a memory associated with one or more devices shown in FIG. 2. For example, data structure 300 may be stored by, or associated with, server 220. In some implementations, data structure 300 may be stored by, or associated with, one or more other components of FIG. 2.

In some implementations, data structure 300 may be exclusively associated with a user. In this situation, data structure 300 may include information regarding people that the user knows.

Data structure 300 may include a collection of fields, such as a name field 310 and an attributes/types/values field 320. Name field 310 may store information identifying a person. The information may include, for example, a first name, a middle name, a last name, and/or a combination of a first name, a middle name, and/or a last name. In some implementations, the information may include a nickname.

Attributes/types/values field 320 may store information relating to the corresponding person identified in name field 310. For example, the entry of attributes/types/values field 320 associated with the name, Bob Smith, may store information relating to Bob Smith. Similarly, the entry of attributes/types/values field 320 associated with the name, Jane Smith, may store information relating to Jane Smith.

As shown, attributes/types/values field 320 may include an attribute field 322, a type field 324, and a value field 326. Attribute field 320 may store information that uniquely identifies a category of information associated with the corresponding person identified in name field 310. Examples categories may include Nickname, Tag (e.g., identifying a category in which the user has classified the person, such as a spouse, a friend, a coworker, etc.), Address, Phone Number, Email Address, Fax Number, Photo, School, Occupation, Birthday, Current Location, etc.

Type field 324 may store information that uniquely identifies a subcategory of a category identified in attribute field 322. For example, the category Address may include sub-categories of Home, Work, etc. The category Phone Number may include sub-categories of Home, Work, Mobile, etc. The category Email Address may include sub-categories of Personal, Work, etc. The category School may include sub-categories of High School, College, etc. In some implementations, type field 324 may include similar sub-categories for a particular category. For example, assuming that the person has multiple personal email addresses, type field 324 may include a Personal 1 subcategory, a Personal 2 subcategory, etc.

Value field 326 may store information, relating to the corresponding person identified in name field 310, for the category and sub-category identified in attribute field 322 and type field 324. As one example, data structure 300 may store information indicating that the nickname of Bob Smith is “Smitty.” Thus, for the category Nickname, value field 326 may store the value Smitty.

In some implementations, value field 326 may store multiple sets of information for a particular category/subcategory for a particular person. For example, value field 326 may store, for category Address and subcategory Home, a current home address for the person, along with one or more previous home addresses.

Although FIG. 3 shows example fields of data structure 300, in some implementations, data structure 300 may include additional fields, different fields, and/or fewer fields than those depicted in FIG. 3.

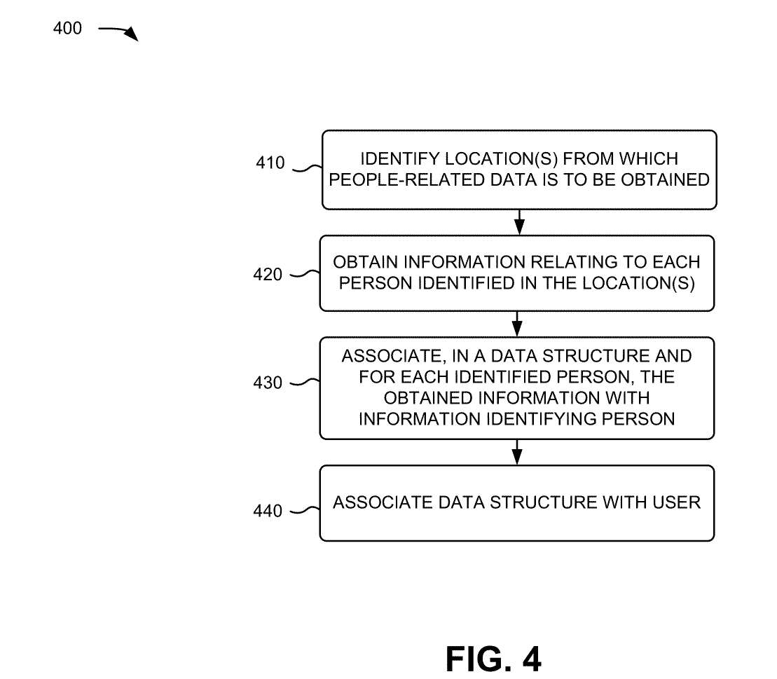

FIG. 4 is a flowchart of an example process 400 for generating a people-related data structure, according to one or more implementations described herein. In some implementations, process 400 may be performed by server 220. In some implementations, process 400 may be performed by one or more other devices instead of, or possibly in conjunction with, server 220, such as user device 210.

Process 400 may include identifying location(s) from which people-related data is to be obtained (block 410). For example, server 220 may receive a request, from a user, indicating that people-related data is to be collected. In response, server 220 may identify one or more memory locations, one or more files, one or more accounts, such as an email account or a social network account, etc. from which the people-related data may be obtained.

In some implementations, server 220 may identify the location(s) automatically. For example, server 220 may identify the types of accounts with which the user is associated, such as an email account, a social network account, etc. and may identify the location(s), associated with those accounts, at which people-related data is stored. In some implementations, server 220 may receive information identifying the location(s) from a user. In these implementations, server 220 may provide a user interface, to the user, that allows the user to identify the location(s). In some implementations, server 220 may identify the location(s) without user input.

Example locations may include an email account, a text messaging account, a phone contacts file, a calendar, a voice communication record, a social network, an Internet location, the user via a manual input of people-related data, and/or other types of locations from which people-related data may be obtained. With respect to the email account, the location(s) may include, for example, an email contacts file, the content of emails, etc. With respect to the text messaging account, the location(s) may include, for example, a text messaging contacts file, the content of text messages, etc. With respect to the voice communication record, the location(s) may include, for example, voice records that identify people who have called the user, the phone numbers of people who have called the user, etc. The voice communication record may also include the content of voicemail messages. With respect to the social network, the location(s) may include, for example, a friends list, contents of postings, etc. With respect to the Internet location, the location(s) may include, for example, a network address of a website from which people-related data may be obtained, such as a website that provides phone number lookups, a website that provides address lookups, etc., a memory location of a search query that is to be used to obtain people-related data, and/or other information that may allow people-related data to be obtained from a network. With respect to manual input, server 220 may provide a user interface, to the user, that allows the user to manually specify people-related data for different people that the user knows.

Process 400 may further include obtaining information relating to each person identified in the location(s) (block 420). For example, server 220 may extract people-related data from the identified locations. As one example, server 220 may parse a phone contacts file and extract the name of each person included in the phone contacts file, along with their corresponding contact information. Thus, if the phone contacts file includes the name Bob Smith, along with 555-555-1234 as Bob's home phone number, 123 Villa Street, Fairfax, Va. 22030 as Bob's home address, and bsmith@personalmail.com as Bob's personal email address, server 220 would extract the name, along with the home phone number, home address, and personal email address.

In some implementations, the same people-related data may be obtained from different ones of the identified locations. For example, the user may have stored Bob Smith's home phone number and address in the user's phone contacts and in the user's email contacts. In these implementations, server 220 may eliminate duplicate information.

Process 400 may further include associating, in a data structure and for each identified person, the obtained information with information identifying the person (block 430). For example, server 220 may create an entry, in a data structure (e.g., data structure 300), and may store the name of the person, along with attribute/type/value information for the person. Continuing with the example above, server 220 may create an entry, in data structure 300, for Bob Smith and may store Bob Smith's name in name field 310, and Address/Home/123 Villa Street, Fairfax, Va. 22030, Phone Number/Home/555-555-1234, and Email/Personal/bsmith@personalemail.com in attributes/types/values field 320.

Process 400 may further include associating the data structure with the user (block 440). For example, server 220 may associate data structure 300 with information identifying the user. Thus, server 220 may limit access to the contents of data structure 300 to only the user.

Although not described above, data structure 300 may also store people-related data for the user. For example, data structure 300 may store the user's own phone numbers, the user's own addresses, the user's own email addresses, etc. Data structure 300 may store information indicating that this people-related data is the user's personal information.

Although FIG. 4 shows example blocks of process 400, in some implementations, process 400 may include additional blocks, different blocks, fewer blocks, and/or differently arranged blocks than those depicted in FIG. 4. Additionally, or alternatively, one or more of the blocks of process 400 may be performed in parallel.

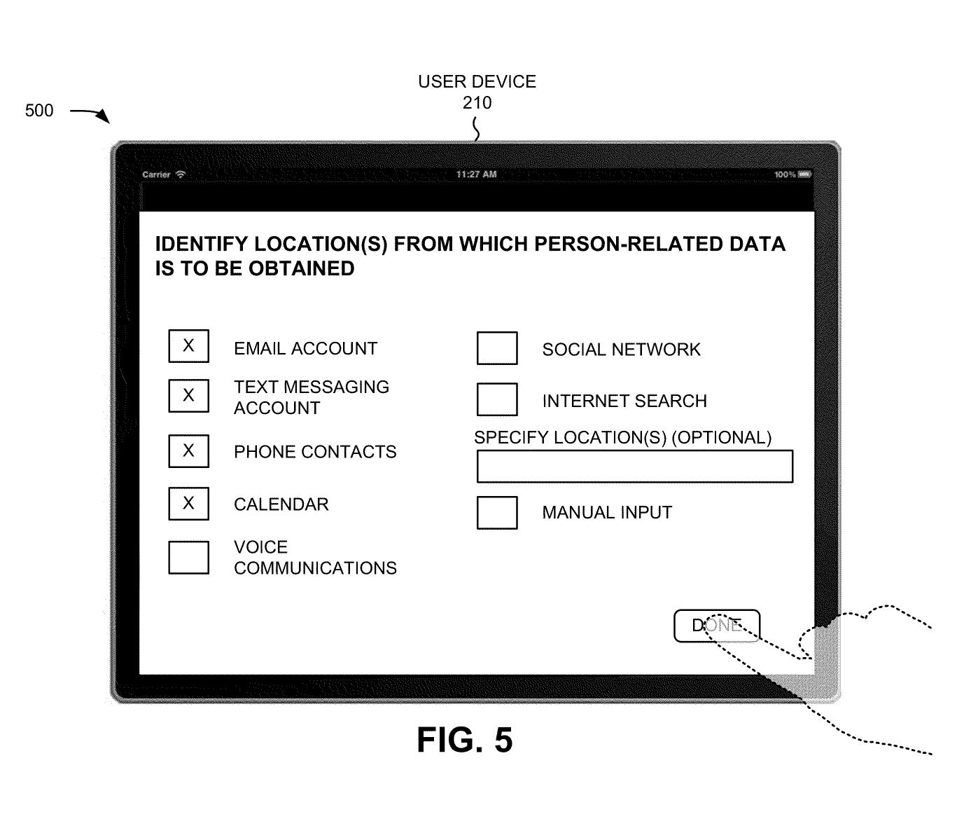

FIG. 5 is an example user interface 500 that may be provided in connection with the process described above with respect to FIG. 4. With respect to FIG. 5, assume that server 220 has provided a user with an interface, such as user interface 500, that allows the user to specify the location(s) from which people-related data is to be obtained. As illustrated in FIG. 5, user interface 500 may allow the user to specify any of the following locations, from which people-related data is to be obtained: an email account, a text messaging account, a phone contacts file, a calendar, voice communications, a social network, an Internet search, or manual input. To select a location, the user may simply select the box next to the desired location. For example, in FIG. 5, the user has selected the following locations from which people-related data is to be obtained: the user's email account, the user's text messaging account, the user's phone contacts, and the user's calendar. Based on the selection of a particular location, server 220 may request that the user identify an account with which the location is associated. Thus, for example, based on the user selecting an email account, server 220 may request that the user specify one or more email accounts with which the user is associated, provide login information for the one or more email accounts, and/or identify a location from which people-related data may be obtained for the one or more email accounts.

Although FIG. 5 shows example fields of user interface 500, in some implementations, user interface 500 may include additional fields, different fields, or fewer fields than those depicted in FIG. 5.

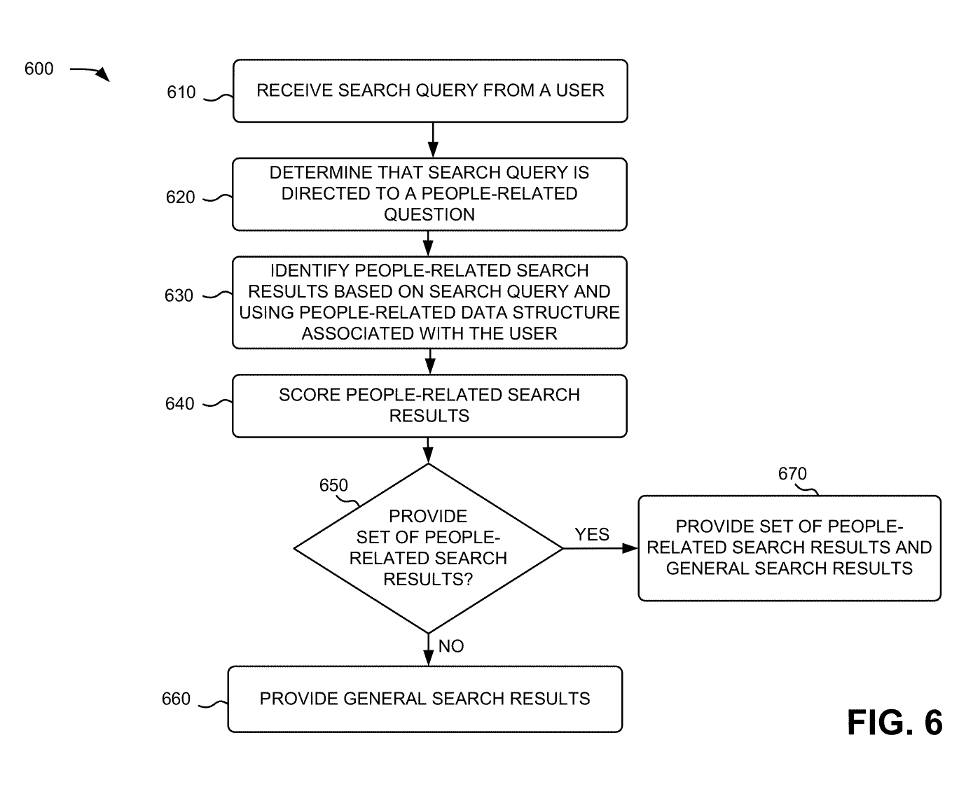

FIG. 6 is a flowchart of an example process 600 for answering a people-related question, according to one or more implementations described herein. In some implementations, process 600 may be performed by server 220. In some implementations, process 600 may be performed by one or more other devices instead of, or possibly in conjunction with, server 220, such as user device 210.

Process 600 may include receiving a search query from a user (block 610). For example, a user may enter a search query into user device 210. In some implementations, the search query may take the form of a natural language query. The search query may be entered via voice input, text input, and/or any other input technique. The user may cause user device 210 to submit the search query to server 220 (e.g., search system 225). Thus, server 220 may receive the search query from user device 210. In some implementations, the received search query may include, or be associated with, information identifying the user.

Process 600 may also include determining that the search query is directed to a people-related question (block 620). For example, server 220 (e.g., search system 225) may analyze the search query to determine whether or not the search query is directed to a people-related question. In some implementations, search system 225 may be configured to detect people-related questions. For example, a model may be created to predict the probability of a particular search query being a people-related question. For example, the model may receive, as training data, different types of people-related questions. During a training phase, grammars of the different types of people-related questions may be analyzed to form a set of rules for predicting a probability of a search query being a people-related question. For example, the rules may specify that the presence of a name in a search query, in combination with the presence of a particular word or words, such as address, phone number, number, email address, birthday, live, etc., is an indication that the search query is a people-related question. The rules may also classify names, in people-related data, as names and certain words as looking for particular types of information. For example, the rules may classify the words “telephone number,” “phone number,” and “number” as a phone number, as opposed to an address.

In some implementations, the creation of the model may include a manual process. For example, the different types of people-related questions, for which search system 225 is to provide answers, may be identified. Example people-related questions may include looking for an email address, a location, or a phone number. For each people-related question, a group of users may be asked how they would ask the people-related question. For example, the group of users may be asked how they might ask their friend, John, for his phone number. The people-related questions, obtained from the group of users, may be used as training data for the model. In some implementations, the people-related questions, obtained from the group of users, may be provided to a second, different group of users. The second group of users may indicate whether each people-related question is a reasonable way to ask for the particular people-related data. The feedback from the second group of users may also be used as training data for the model. In some implementations, information from data structure 300 may be used as training data. For example, unusual names that appear in data structure 300 may be fed into the model as training data. Once trained, search system 225 may use the model to predict the probability of search queries being not only a people-related question, but a particular type of people-related question (e.g., a people-related question directed to finding a home address of a person named John).

Process 600 may further include identifying people-related search results based on the search query and using the people-related data structure associated with the user (block 630). For example, server 220 (e.g., search system 225) may parse and normalize the search query. In some implementations, search system 225 may restructure the search query based on fields 310, 322, 324, and/or 326 of data structure 300. For example, search system 225 may restructure the search query so as to identify which part of the search query corresponds to a name, which part of the search query corresponds to an attribute, which part of the search query corresponds to a type, and/or which part of the search query corresponds to a value. In some implementations, search system 225 may restructure a search query into the form:
{name:“A” attribute:“B” type:“C” value:“D”}
   where A, B, C, and D correspond to information from the search query. By way of example, assume that the search query is “where does john doe live” or “what's john doe's home address.” In this example, search system 225 may restructure the search query as:
{name:“john doe” attribute:“address” type:“home”}.
   As another example, assume that the search query is “who do I know who lives in Fairfax, Va.” In this example, search system 225 may restructure the search query as:
{attribute:“address” type:“home” value:“Fairfax, Va.”}.
   In some implementations, search system 225 may restructure the search query into another form.

In some implementations, search system 225 may identify a data structure, such as data structure 300, with which the user is associated. For example, search system 225 may use the information identifying the user (received in connection with the search query) to identify a data structure 300 associated with that user.

Search system 225 may identify people-related search results using the identified data structure 300 and based on the restructured search query. For example, search system 225 may compare the names, attributes, types, and/or values of the restructured search query to data in data structure 300 to obtain a list of people-related search results. By way of example, assume that search system 225 restructured a search query as {name:“clark” attribute:“address” type:“work”}. Search system 225 may identify people named Clark in data structure 300 and obtain, for each identified person and from data structure 300, a work address.

Process 600 may additionally include scoring the people-related search results (block 640). For example, server 220 (e.g., search system 225) may generate scores for each people-related search result, in the list of people-related search results. Search system 225 may generate the scores based on how well the entry, in data structure 300, matches the information in the restructured search query. For example, if the restructured query includes the name Bob and data structure 300 includes information for a first person with a first name of Bob and a second person with a first name of Robert, search system 225 may generate a higher score for the first person (e.g., since the first person's name, in data structure 300, exactly matches the name in the restructured search query) than the second person.

In some implementations, search system 225 may modify the generated scores based on one or more factors. For example, search system 225 may modify the score, for a people-related search result, based on a tag score of the people-related search result. As indicated above, data structure 300 may store a tag, for a person identified in data structure 300, that indicates a relationship that the person has to the user. In some implementations, a tag score of a search result may be generated based on the tag associated with the people-related search result in data structure 300. For example, a higher tag score may be generated for a people-related search result that is associated with a tag that indicates that the person is a family member than a people-related search result that is not associated with a tag. Similarly, a higher tag score may be generated for a people-related search result that is associated with a tag that indicates that the person is a family member than a people-related search result that is associated with a tag that indicates that the person is a former coworker. Thus, continuing with the example above, assuming that the first person, Bob, has been tagged as a former coworker and the second person, Robert, has been tagged as a spouse, search system 225 may generate a higher tag score for the second person than the first person based on the tags with which the first person and the second person are associated. In some implementations, the user may assign a weight to one or more tags identified in data structure 300. In these implementations, search system 225 may generate tag scores based on the assigned weights.

Additionally, or alternatively, search system 225 may modify the score, for a people-related search result, based on a location score of the people-related search result. In some implementations, the location score of a people-related search result may be generated based on the geographic distance between a current location of the user and a current location of the person corresponding to the people-related search result, the geographic distance between a current location of the user and a home or work address of the person corresponding to the people-related search result, or the like. For example, a higher location score may be generated for a people-related search result that is associated with an address that is geographically closer to the current location of the user than a people-related search result that is associated with an address that is geographically further away from the current location of the user. Continuing with the example above, assume that the second person, Robert, lives in the same state as the user and that the first person, Bob, lives in a different country than the user. Moreover, assume that the search query is “directions to Bob's house.” In this example, search system 225 may generate a higher location score for the second person than the first person based on where the first person and second person live. In some implementations, the user may assign a weight to one or more locations identified in data structure 300. For example, the user may assign a higher weight to locations close to where the user lives and to locations where the user grew up than other locations. In these implementations, search system 225 may generate location scores based on the assigned weights.

Additionally, or alternatively, search system 225 may modify the score, for a people-related search result, based on a temporal score of the people-related search result. In some implementations, the temporal score of a people-related search result may be generated based on user activity data, associated with the user, with regard to the person corresponding to the people-related search result, such as, for example, whether the user has recently performed a search for information regarding the person; whether the person has recently shown up in people-related search results and the user has taken an action in connection with the people-related search result corresponding to the person; whether the user has communicated with the person recently or the person has communicated with the user recently (e.g., through email, phone, text messaging, instant messaging, etc.); whether a calendar entry identifying the person has been recently added, deleted, or modified; whether a calendar entry identifying the person relates, in time, to a time and/or date on which the search query was received; whether the user has recently interacted with the person's social network page; whether the user has recently taken a picture of the person; or the like. Continuing with the example above, assume that the search query is “what's Bob's phone number.” Further, assume that 10 minutes ago, the user performed a search for the second person's (i.e., Robert's) home address. In this example, search system 225 may generate a higher temporal score for the second person than the first person based on the user recently performing a search for information relating to the second person. In some implementations, the user may assign a weight to one or more particular types of user activity data. For example, the user may assign a higher weight to recent communications than to recent social network activity. In these implementations, search system 225 may generate temporal scores based on the assigned weights.

Additionally, or alternatively, search system 225 may modify the score, for a people-related search result, based on an interaction score of the people-related search result. In some implementations, the interaction score of a people-related search result may be generated based on a quantity of user activity data, associated with the user, with regard to the person corresponding to the people-related search result, such as, for example, the quantity of searches that the user has performed relating the person; the quantity of times that the person has shown up in people-related search results and the user has performed an action in relation to the people-related search result corresponding to the person; the quantity of communications that the user has had with the person or the person has had with the user (e.g., through email, phone, text messaging, instant messaging, etc.); the quantity of entries in the user's calendar that identifies the person; the quantity of locations that the user is connected to the person (e.g., the user has stored information relating to the person in the user's phone contacts, the user's email contacts, the user's social network, etc.); the quantity of interaction, by the user, with the person's social network page; the quantity of interactions, by the person, with the user's social network page; the quantity of pictures that the user has taken and/or stored that depict the person; or the like. Continuing with the example above, assume that the search query is “what's Bob's phone number.” Further, assume that, over the past week, the user has communicated with the second person, Robert, on 10 occasions and has not communicated with the first person, Bob, in 10 months. In this example, search system 225 may generate a higher interaction score for the second person than the first person based on the quantity of interaction the user has had with the second person. In some implementations, the user may assign a weight to one or more particular types of user activity data or one or more quantities of user activity data. For example, the user may assign a higher weight to a quantity of communications than to the same quantity of social network activity. In these implementations, search system 225 may generate interaction scores based on the assigned weights.

Additionally, or alternatively, search system 225 may modify the score, for a people-related search result, based on an authority score of the people-related search result. In some implementations, the authority score of a people-related search result may be generated based on a public profile of the person. The public profile may correspond to a social network profile of the person, news documents relating to the person, or the like. Continuing with the example above, assume again that the search query is “what's Bob's phone number.” Further, assume that, the second person, Robert, is a very well known and respected CEO of a large corporation and that the first person, Bob, is a software engineer for a small defense company. In this example, search system 225 may generate a higher authority score for the second person than the first person based on the public profile associated with the second person.

Additionally, or alternatively, search system 225 may modify the score, for a people-related search result, based on a photo score of the people-related search result. In some implementations, the photo score of a people-related search result may be generated based on whether data structure 300 includes a photo of the person corresponding to the people-related search result. Continuing with the example above, assume again that the search query is “what's Bob's phone number.” Further, assume that, data structure 300 includes a photo of the second person, Robert, and does not include a photo of the first person, Bob. In this example, search system 225 may generate a higher photo score for the second person than the first person based on data structure 300 storing a photo of the second person and not the first person.

In some implementations, search system 225 may generate a total score for a people-related search result based on a combination of the score and the tag score, the location score, the temporal score, the interaction score, the authority score, and/or the photo score. In some implementations, search system 225 may generate a total score for a people-related search result based on a combination of the score, the tag score, the location score, the temporal score, the interaction score, the authority score, and the photo score. In some implementations, search system 225 may generate a total score for a people-related search result based on a weighted combination of the score, the tag score, the location score, the temporal score, the interaction score, the authority score, and/or the photo score. For example, search system 225 may assign a weight value to the score, the tag score, the location score, the temporal score, the interaction score, the authority score, and/or the photo score. The weight values may differ—in other words, the amount that each of the score, the tag score, the location score, the temporal score, the interaction score, the authority score, and/or the photo score contributes to the total score may vary. Search system 225 may combine the weighted score, the weighted tag score, the weighted location score, the weighted temporal score, the weighted interaction score, the weighted authority score, and/or the weighted photo score to generate the total score.

In some implementations, search system 225 may select a set of people-related search results based on their scores. For example, search system 225 may select the top scoring X people-related search results (X>1). In some implementations, search system 225 may select only the top scoring people-related search result (X=1). In some implementations, search system 225 may select the top scoring five (5) people-related search results (X=5).

In some implementations, search system 225 may perform, in addition to performing a people-related data search, one or more other categories of searches, such as a general search, an image search, a video search, a news search, a product search, etc. based on the search query. In these implementations, search system 225 may obtain a ranked list of search results based on performing the one or more other categories of searches. This ranked list of search results will be referred to as “general search results” hereinafter.

Process 600 may further include determining whether to provide the selected set of people-related search results (block 650). In some implementations, despite the fact that search system 225 has identified a search query as a people-related question, server 220 (e.g., search system 225) may determine that the set of people-related search results are not to be provided. For example, search system 225 may compare the score of the people-related search result having the highest score to a threshold. If the score does not equal or exceed the threshold, search system 225 may determine that the set of people-related search results is not to be provided. On the other hand, if the score equals or exceeds the threshold, search system 225 may determine that the set of people-related search results is to be provided.

In some implementations, search system 225 may determine whether or not to provide the set of people-related search results based on the score of one or more general search results. For example, in some implementations, the score of a general search result may be very high and the score of the highest scoring people-related search result may be very low. In these implementations, search system 225 may determine that the set of people-related search results is not to be provided. As an example, assume that the search query is “directions to Sabrina's house” and that a very popular movie is currently in theaters that is also entitled, “Directions to Sabrina's House.” Assume further that search system 225 determines that the user only knows a single person named Sabrina and that the user has not associated a tag with Sabrina, that the user is not located in the same country as Sabrina's home address, that there is no recent user activity data relating to Sabrina, that the user had only communicated with Sabrina once and that was over 2 years ago, that Sabrina's authority score is low, and that data structure 300 does not store a photo of Sabrina. In this example, search system 225 may determine that the set of people-related search results is not to be provided to the user in response to the search query.

In those situations where the set of people-related search results is not to be provided (block 650—NO), process 600 may include providing the general search results (block 660). For example, server 220 (e.g., search system 225) may provide a document, to user device 210, that includes one or more of the general search results. User device 210 may receive the document and cause the document to be displayed to the user.

In those situations where the set of people-related search results is to be provided (block 650—YES), process 600 may include providing the set of people-related search results and the general search results (block 670). For example, server 220 (e.g., search system 225) may provide a document, to user device 210, that includes information relating to the set of people-related search results and one or more of the general search results. In some implementations, the information may include the name of the person, a photo of the person (if stored by data structure 300), and the information requested in the search query. If the search query relates to obtaining a phone number and data structure 300 stores multiple phone numbers for the person (e.g., a mobile phone number, a home phone number, and a work phone number), search system 225 may provide all of the phone numbers, or a subset of the phone numbers based on one or more factors, such as the quantity of times that the user has called the person at each of the phone numbers. In some implementations, the information may include the name of the person, a photo of the person (if stored by data structure 300), the information requested in the search query, and some or all of the other information, stored by data structure 300, for the person.

In some implementations, the information may include information calculated by search system 225 (or another device). For example, for the search query “how old is Bob?,” search system 225 (or another device) may calculate Bob's age (e.g., based on identifying Bob's birthday in data structure 300) and include the calculated value in the document. As another example, for the search query “what's the distance between me and Bob,” search system 225 may obtain a current location of the user and may obtain a current location of Bob (e.g., from a location sharing service), and may calculate the distance between the user and Bob. Search system 225 may include the calculated distance in the document.

In some implementations, the people-related search result(s) may be visually separated, in the document, from the general search results. In some implementations, the people-related search result(s) may be displayed at a top portion of the document (i.e., above the general search results). In some implementations, the people-related search result(s) may be displayed to the right (or left) of the general search results. In some implementations, the people-related search result(s) may be at a particular position within the general search results (e.g., at position two or three). In some implementations, the location of the people-related search result(s) may be based on the total score generated by search system 225 or based on other factors.

In some implementations, the document may include an interactive element that allows the user to perform one or more actions. For example, in the situation where set of people-related search results includes more than one of the highest ranking people-related search results, search system 225 may provide a document that displays less than all of the set of people-related search results. In this situation, search system 225 may associate an interactive element with the displayed people-related search result(s) that allows the user to obtain the additional people-related search results. In some implementations, the interactive element may allow the user to obtain a current location of the people-related search result. Upon selection of the interactive element, user device 210 may obtain, from a location sharing service, the current location of the person, corresponding to the people-related search result, and provide a map that displays the person's location. In some implementations, the interactive element may allow the user to communicate with the people-related search result. For example, when the information, associated with the people-related search result, includes a phone number, selection of the phone number may cause user device 210 to place a phone call using the phone number. In some implementations the interactive element may take the form of a map. For example, assume that the search query is “where does Bob live?” The document may include Bob's name, a picture of Bob, Bob's home address, and a map that depicts the location of Bob's home. Selection of the map may cause user device 210 to obtain and provide directions to Bob's house.

Although FIG. 6 shows example blocks of process 600, in some implementations, process 600 may include additional blocks, different blocks, fewer blocks, and/or differently arranged blocks than those depicted in FIG. 6. Additionally, or alternatively, one or more of the blocks of process 600 may be performed in parallel.

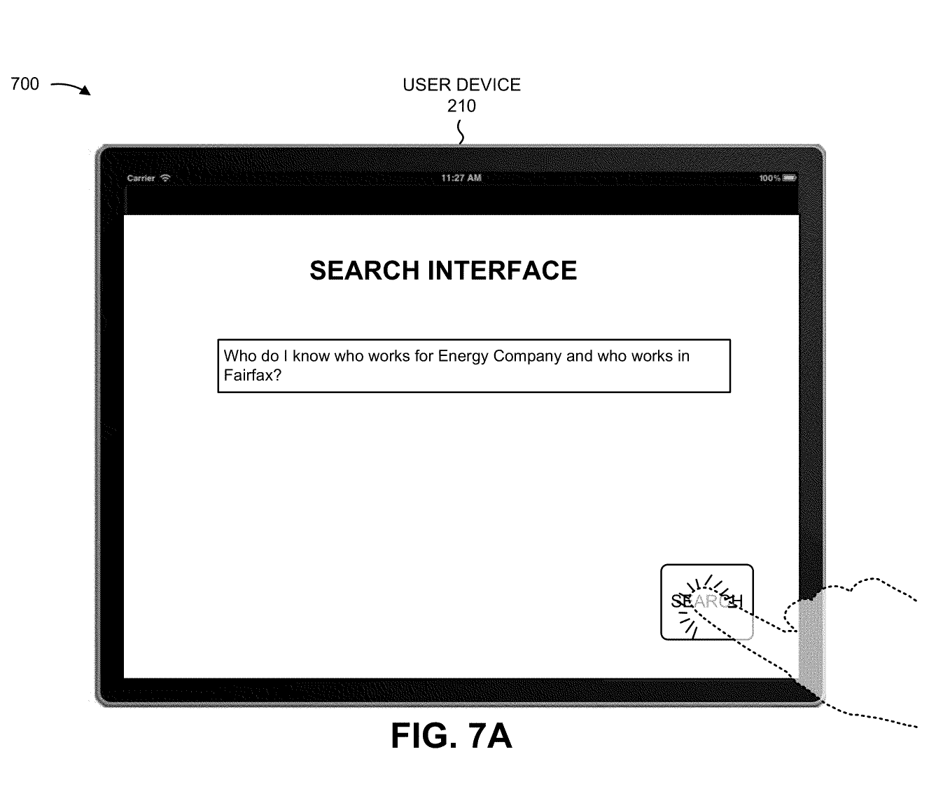

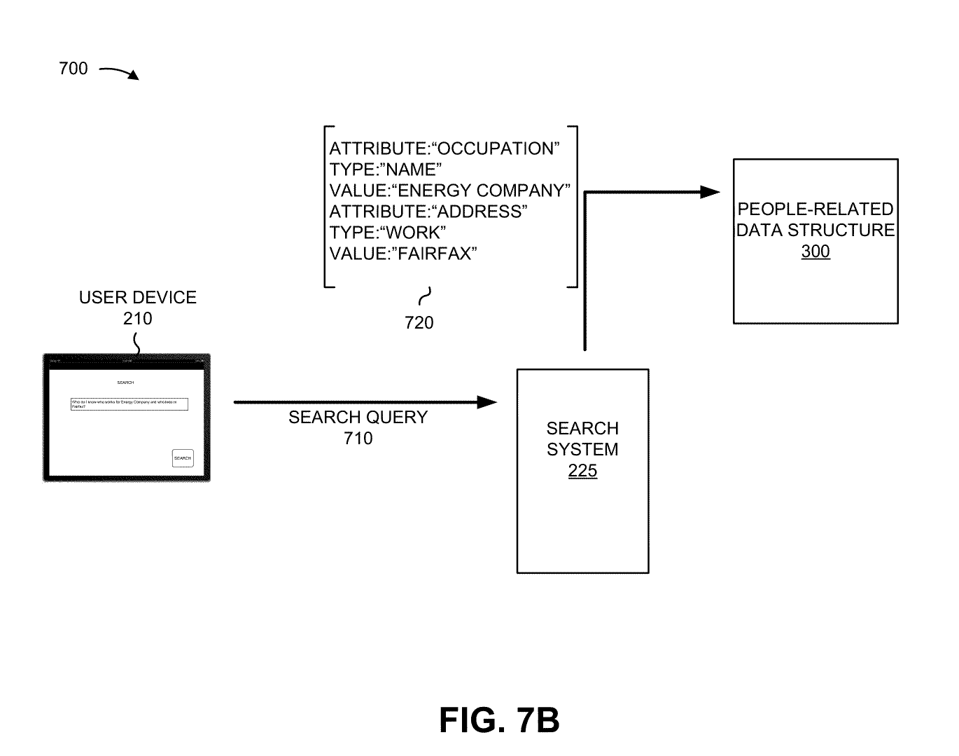

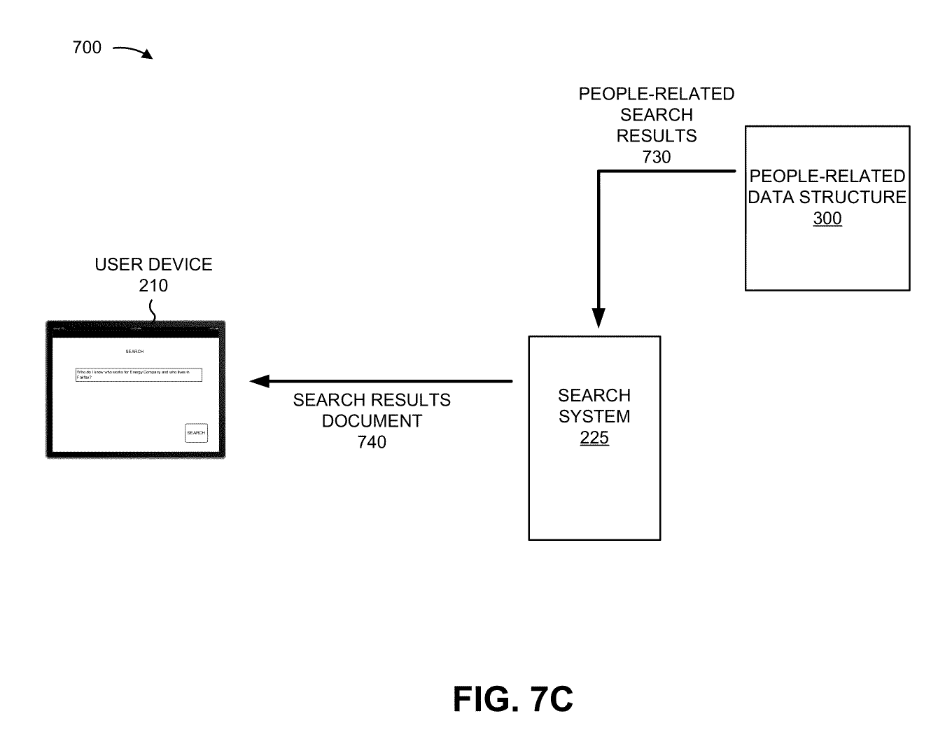

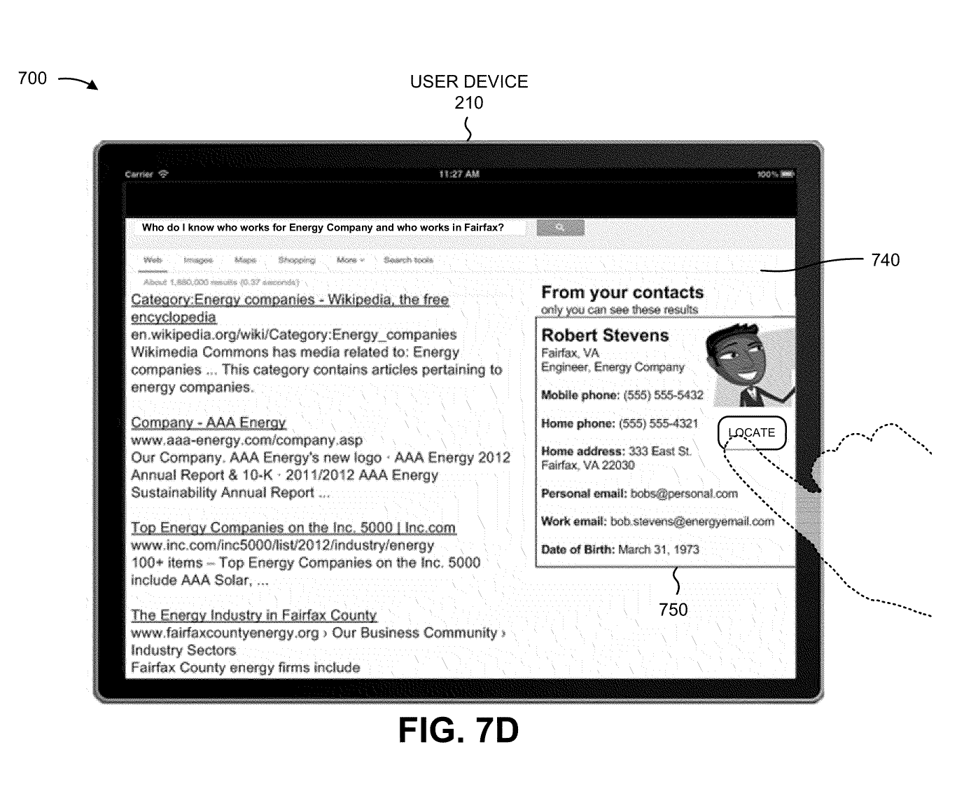

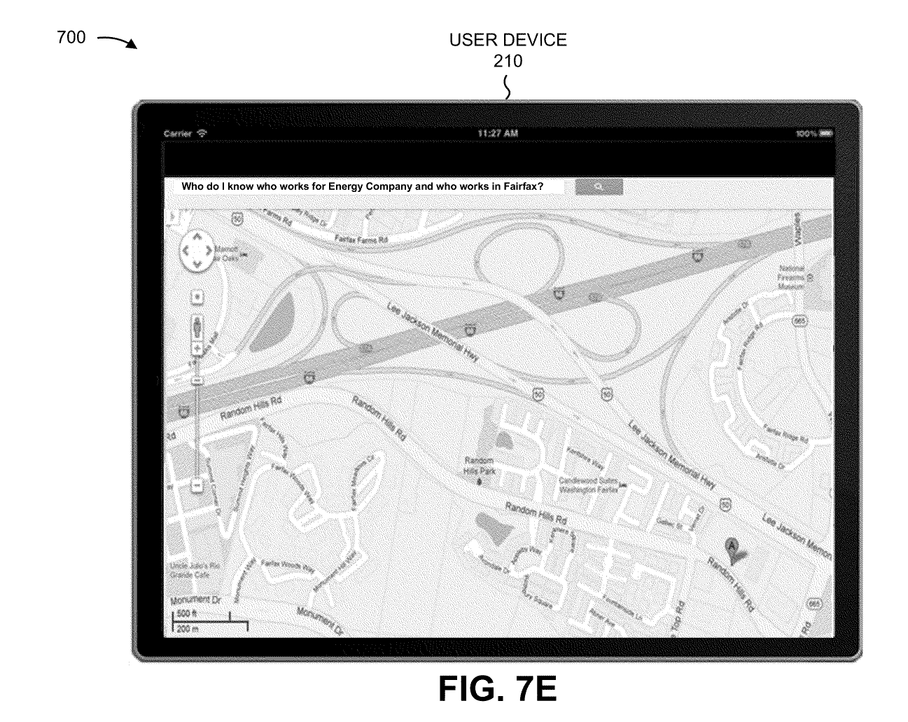

FIGS. 7A-7E are an example 700 of the process described in connection with FIG. 6. In example 700, assume a user recently read that Energy Company, a national power company, is laying off workers in their Fairfax, Virginia office. Upon reading the news, the user wants to find out if he knows anyone who will be affected by the layoff. Thus, with reference to FIG. 7A, assume that the user accesses a search interface, associated with user device 210, to perform a search for the information. The user may enter the following search query: “Who do I know who works for Energy Company and who works in Fairfax?” The user may cause user device 210 to submit the search query.

With reference to FIG. 7B, search system 225 may receive search query 710, from user device 210, analyze search query 710, and determine that search query 710 corresponds to a people-related question. In response, search system 225 may restructure search query 710 to form restructured search query 720. Restructured search query may be represented as follows: {Attribute:“Occupation” Type:“Name” Value:“Energy Company” Attribute:“Address” Type:“Work” Value:“Fairfax”}. Search system 225 may compare the information in restructured search query 720 to the information stored in a people-related data structure 300, associated with the user.

With reference to FIG. 7C, search system 225 may obtain a list of people-related search results 730 based on restructured search query 720. Search system 225 may generate a total score for each people-related search result, in the list of the people-related search results, based one or more of the scores described above with respect to process 600 of FIG. 6. Search system 225 may also perform one or more other categories of searches based on search query 710 to obtain general search results. Search system 225 may generate a search results document 740 that includes one or more of the highest scoring people-related search results and one or more of the general search results. Search system 225 may provide search results document 740 to user device 210.

With reference to FIG. 7D, user device 210 may display search results document 740. As shown, search results document 740 includes a section 750 that provides an answer to the people-related question corresponding to search query 710. For example 700, search system 225 identified a single person, in people-related data structure 300, that satisfied search query 710 and search results document 740 includes information identifying the person, as Robert Stevens.

As further shown in FIG. 7D, section 750 includes a LOCATE button, which, upon selection, causes information relating to the current location of the person to be provided. Assume, for example 700, that the user is interested in visiting Bob to see if Bob has been affected by the layoff. Thus, the user may select the LOCATE button. In response, user device 210 may contact a location sharing service to obtain the current location of Robert Stevens. With reference to FIG. 7E, user device 210 may cause a map to be displayed that shows the current location of Robert Stevens. In this way, the user can easily obtain an answer to a natural language people-related question.

As indicated above, FIGS. 7A-7E are provided merely as an example. Other examples are possible and may differ from what was described with regard to FIGS. 7A-7E.

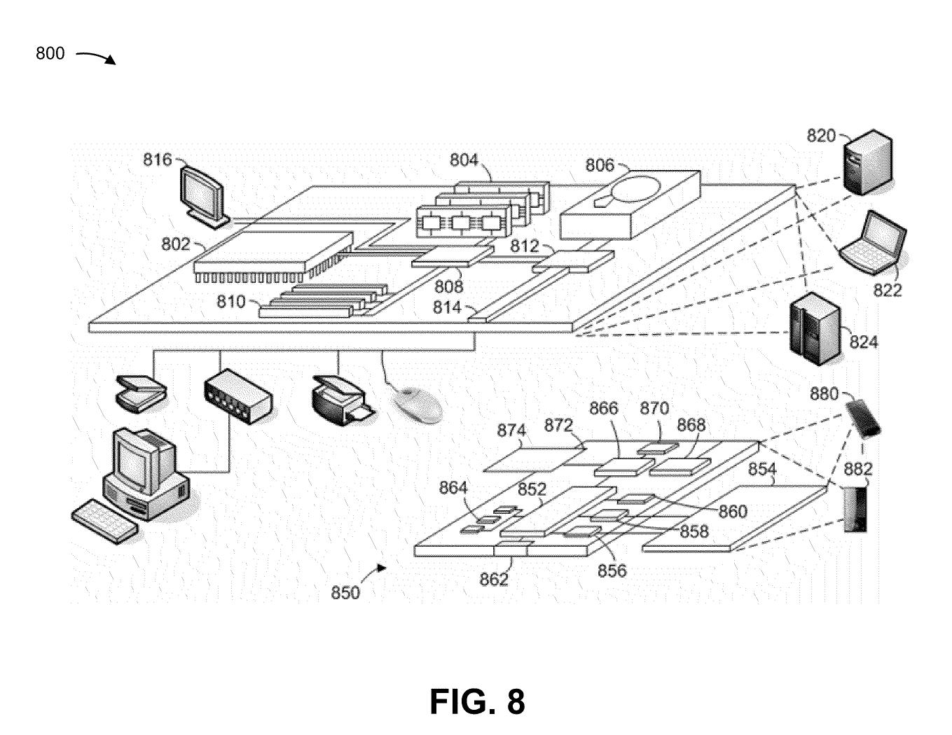

FIG. 8 is an example of a generic computing device 800 and a generic mobile computing device 850, which may be used with the techniques described here. Generic computing device 800 or generic mobile computing device 850 may correspond to, for example, a user device 210 and/or a server 220, 230, and/or 240. Computing device 800 is intended to represent various forms of digital computers, such as laptops, desktops, workstations, personal digital assistants, servers, blade servers, mainframes, and other appropriate computers. Mobile computing device 850 is intended to represent various forms of mobile devices, such as personal digital assistants, cellular telephones, smart phones, tablet computers, and other similar computing devices. The components shown in FIG. 8, their connections and relationships, and their functions, are meant to be examples only, and are not meant to limit implementations described herein.

Computing device 800 may include a processor 802, a memory 804, a storage device 806, a high-speed interface 808 connecting to memory 804 and high-speed expansion ports 810, and a low-speed interface 812 connecting to a low-speed expansion port 814 and a storage device 806. Each of components 802, 804, 806, 808, 810, 812, and 814, are interconnected using various buses, and may be mounted on a common motherboard or in other manners as appropriate. Processor 802 can process instructions for execution within computing device 800, including instructions stored in memory 804 or on storage device 806 to display graphical information for a graphical user interface, also referred to as a “GUI,” on an external input/output device, such as display 816 coupled to high-speed interface 808. In some implementations, multiple processors and/or multiple buses may be used, as appropriate, along with multiple memories and types of memory. Also, multiple computing devices 800 may be connected, with each device providing portions of the necessary operations, as a server bank, a group of blade servers, or a multi-processor system, etc.

Memory 804 stores information within computing device 800. In some implementations, memory 804 includes a volatile memory unit or units. In some implementations, memory 804 may include a non-volatile memory unit or units. Memory 804 may also be another form of computer-readable medium, such as a magnetic or optical disk. A computer-readable medium may refer to a non-transitory memory device. A memory device may refer to storage space within a single physical storage device or spread across multiple physical storage devices.

Storage device 806 is capable of providing mass storage for computing device 800. In some implementations, storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 804, storage device 806, or a memory on processor 802.

High-speed interface 808 manages bandwidth-intensive operations for computing device 800, while low-speed interface 812 manages lower bandwidth-intensive operations. Such allocation of functions is provided for explanatory purposes only. In some implementations, high-speed interface 808 may be coupled to memory 804, display 816, e.g., through a graphics processor or accelerator, and to high-speed expansion ports 810, which may accept various expansion cards. In some implementations, low-speed interface 812 may be coupled to storage device 806 and low-speed expansion port 814. Low-speed expansion port 814, which may include various communication ports, e.g., USB, Bluetooth, Ethernet, wireless Ethernet, etc., may be coupled to one or more input/output devices, such as a keyboard, a pointing device, a scanner, or a networking device such as a switch or router, e.g., through a network adapter.

Computing device 800 may be implemented in a number of different forms, as shown in the figure. For example, computing device 800 may be implemented as a standard server 820, or multiple times in a group of such servers. Computing device 800 may also be implemented as part of a rack server system 824. In addition, computing device 800 may be implemented in a personal computer, such as a laptop computer 822. Alternatively, components from computing device 800 may be combined with other components in a mobile device, such as mobile computing device 850. Each of such devices may contain one or more of computing devices 800, 850, and an entire system may be made up of multiple computing devices 800, 850 communicating with each other.

Mobile computing device 850 may include a processor 852, a memory 864, an input/output device, such as a display 854, a communication interface 866, and a transceiver 868, among other components. Mobile computing device 850 may also be provided with a storage device, such as a micro-drive or other device, to provide additional storage. Each of the components 852, 864, 854, 866, and 868 are interconnected using various buses, and several of the components may be mounted on a common motherboard or in other manners as appropriate.

Processor 852 can execute instructions within mobile computing device 850, including instructions stored in memory 864. Processor 852 may be implemented as a chipset of chips that include separate and multiple analog and digital processors. Processor 852 may provide, for example, for coordination of the other components of mobile computing device 850, such as control of user interfaces, applications run by mobile computing device 850, and wireless communication by mobile computing device 850.

Processor 852 may communicate with a user through control interface 858 and display interface 856 coupled to a display 854. Display 854 may be, for example, a Thin-Film-Transistor Liquid Crystal Display or an Organic Light Emitting Diode display, or other appropriate display technology. Display interface 856 may include appropriate circuitry for driving display 854 to present graphical and other information to a user. Control interface 858 may receive commands from a user and convert the commands for submission to processor 852. In addition, an external interface 862 may be provided in communication with processor 852, so as to enable near area communication of mobile computing device 850 with other devices. External interface 862 may provide, for example, for wired communication in some implementations, or for wireless communication in some implementations, and multiple interfaces may also be used.

Memory 864 stores information within mobile computing device 850. Memory 864 can be implemented as one or more of a computer-readable medium or media, a volatile memory unit or units, or a non-volatile memory unit or units. Expansion memory 874 may also be provided and connected to mobile computing device 850 through expansion interface 872, which may include, for example, a Single In Line Memory Module, also referred to as “SIMM,” card interface. Such expansion memory 874 may provide extra storage space for device 850, or may also store applications or other information for mobile computing device 850. Specifically, expansion memory 874 may include instructions to carry out or supplement the processes described herein, and may include secure information also. Thus, for example, expansion memory 874 may be provided as a security module for mobile computing device 850, and may be programmed with instructions that permit secure use of mobile computing device 850. In addition, secure applications may be provided via the SIMM cards, along with additional information, such as placing identifying information on the SIMM card in a non-hackable manner.

Expansion memory 874 may include, for example, flash memory and/or NVRAM memory. In some implementations, a computer program product is tangibly embodied in an information carrier. The computer program product contains instructions that, when executed, perform one or more methods, such as those described above. The information carrier is a computer-or machine-readable medium, such as memory 864, expansion memory 874, or a memory on processor 852, that may be received, for example, over transceiver 868 or external interface 862.

Mobile computing device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 868. In addition, short-range communication may occur, such as using a Bluetooth, WiFi, or other such transceiver. In addition, a Global Positioning System, also referred to as “GPS,” receiver module 870 may provide additional navigation- and location-related wireless data to mobile computing device 850, which may be used as appropriate by applications running on mobile computing device 850.

Mobile computing device 850 may also communicate audibly using audio codec 860, which may receive spoken information from a user and convert the received spoken information to digital information. Audio codec 860 may likewise generate audible sound for a user, such as through a speaker, e.g., in a handset of mobile computing device 850. Such sound may include sound from voice telephone calls, may include recorded sound, e.g., voice messages, music files, etc., and may also include sound generated by applications operating on mobile computing device 850.

Mobile computing device 850 may be implemented in a number of different forms, as shown in the figure. For example, mobile computing device 850 may be implemented as a cellular telephone 880. Mobile computing device 850 may also be implemented as part of a smart phone 882, personal digital assistant, or other similar mobile device.

Various implementations of the systems and techniques described herein can be realized in digital electronic circuitry, integrated circuitry, specially designed application specific integrated circuits, computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, e.g., magnetic discs, optical disks, memory, Programmable Logic Devices, used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, e.g., a cathode ray tube or liquid crystal display monitor, for displaying information to the user and a keyboard and a pointing device, e.g., a mouse or a trackball, by which the user can provide input to the computer. Other kinds of devices can be used to provide for interaction with a user as well. For example, feedback provided to the user can be any form of sensory feedback, e.g., visual feedback, auditory feedback, or tactile feedback. Also, input from the user can be received in any form, including acoustic, speech, or tactile input.

The systems and techniques described herein can be implemented in a computing system that includes a back end component, e.g., as a data server, or that includes a middleware component, e.g., an application server, or that includes a front end component, e.g., a client computer having a graphical user interface or a Web browser through which a user can interact with some implementations of the systems and techniques described here, or any combination of such back end, middleware, or front end components. The components of the system can be interconnected by any form or medium of digital data communication, e.g., a communication network. Examples of communication networks include a LAN, a WAN, and the Internet.

The foregoing description provides illustration and description, but is not intended to be exhaustive or to limit the implementations to the precise form disclosed. Modifications and variations are possible in light of the above teachings or may be acquired from practice of the implementations.

As used herein, the term component is intended to be broadly interpreted to refer to hardware or a combination of hardware and software, such as software executed by a processor.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with the phrase “one or more.” Where only one item is intended, the term “one” or similar language is used. Further, the phrase “based on” is intended to mean “based, at least in part, on” unless explicitly stated otherwise.

What is claimed is:

1. A method comprising:
receiving, by one or more computer devices, a search query from a user of a user device;
determining, by the one or more computer devices, that the search query is a people-related question;
identifying, by the one or more computer devices, based on determining that the search query is the people-related question, and using a data structure, a set of people related to the search query,
the data structure being associated with the user, and
the data structure storing people-related data for a plurality of people with which the user is associated,
the set of people being a subset of the plurality of people;
determining, by the one or more computer devices, whether to provide information relating to the set of people; and
selectively providing, by the one or more computer devices, to the user device, and based on determining whether to provide the information relating to the set of people, one of:
a first document that identifies at least one person in the set of people and provides information relating to the at least one person,
the information, relating to the at least one person, providing an answer to the people-related question, or
a second document that excludes the information relating to the set of people.

2. The method of claim 1, further comprising:
restructuring the search query to form a restructured search query, and
where identifying the set of people include:
comparing information in the restructured search query to information in the data structure, and
identifying the set of people based on the comparison.

3. The method of claim 1, where the set of people includes a first person and a second person, and
where the method further comprises:
generating a first score for the first person,
generating a second score for the second person, and
selecting the at least one person based on the first score and the second score.

4. The method of claim 3, where generating the first score is based on at least one of:
a user-specified category with which the first person is associated,
a geographic distance between the user and the first person,
an indication of how recently the user has interacted with the first person,
an indication of a quantity of interactions the user has had with the first person,
an authority score associated with the first person, or
an indication of whether the data structure stores a photo of the first person.

5. The method of claim 1, where determining whether to provide information relating to the set of people includes:
generating a score for each person in the set of people,
comparing a highest score, of the generated scores, to a threshold, and
determining to provide the information relating to the set of people when the highest score equals or exceed the threshold.

6. The method of claim 1, further comprising:
performing a general search, and
obtaining general search results based on performing the general search, and
where determining whether to provide information relating to the set of people includes:
generating a score for each person in the set of people, and
determining whether to provide the information relating to the set of people based on the generated scores and information relating to the general search results.

7. A computer-readable medium storing instructions, the instructions comprising:
one or more instructions, which, when executed by a processor, cause the processor to:
receive a search query from a user of a user device;
determine that the search query is a people-related question;
identify, based on determining that the search query is the people-related question and using a data structure, a set of people related to the search query,
the data structure being associated with the user, and
the data structure storing people-related data for a plurality of people with which the user is associated,
the set of people being a subset of the plurality of people;
determine whether to provide information relating to the set of people; and
selectively provide, to the user device and based on determining whether to provide the information relating to the set of people, one of:
a first document that identifies at least one person in the set of people and provides information relating to the at least one person,
the information, relating to the at least one person, providing an answer to the people-related question, or
a second document that excludes the information relating to the set of people.

8. The computer-readable medium of claim 7, where the one or more instructions further cause the processor to:
restructure the search query to form a restructured search query, and
where the one or more instructions to cause the processor to identify the set of people further cause the processor to:
compare information in the restructured search query to information in the data structure, and
identify the set of people based on the comparison.

9. The computer-readable medium of claim 7, where the set of people includes a first person and a second person, and
where the one or more instructions further cause the processor to:
generate a first score for the first person,
generate a second score for the second person, and
select the at least one person based on the first score and the second score.

10. The computer-readable medium of claim 9, where the one or more instructions to cause the processor to generate the first score and to generate the second score include:
one or more instructions to cause the processor to generate the first score and to generate the second score based on at least one of:
user-specified categories with which the first person and the second person are associated,
geographic distances between the user and each of the first person and the second person,
indications of how recently the user has interacted with the first person and the second person,
indications of a quantity of interactions the user has had with the first person and a quantity of interactions the user has had with the second person,
authority scores associated with the first person and the second person, or
indications of whether the data structure stores a photo of the first person and the second person.

11. The computer-readable medium of claim 7, where the one or more instructions to cause the processor to determine whether to provide information relating to the set of people include:
one or more instructions to cause the processor to:
generate a score for each person in the set of people,
compare a highest score, of the generated scores, to a threshold, and
determine to provide the information relating to the set of people when the highest score equals or exceed the threshold.

12. The computer-readable medium of claim 7, where the one or more instructions further cause the processor to:
perform a general search, and
obtain general search results based on performing the general search, and
where the one or more instructions to cause the processor to determine whether to provide information relating to the set of people include:
one or more instructions to cause the processor to:
generate a score for each person in the set of people, and
determine whether to provide the information relating to the set of people based on the generated scores and information relating to the general search results.

13. The computer-readable medium of claim 7, where the one or more instructions to selectively provide the one of the first document or the second document include:
one or more instructions to provide the first document,
the first document including an interactive element,
the interactive element allowing the user to:
obtain information relating to people, other than the at least one person, in the set of people,
obtain a current location of the at least one person,
obtain directions to the current location of the at least one person,
obtain directions to an address associated with the at least one person, or
communicate with the at least one person.

14. The computer-readable medium of claim 7, where the one or more instructions to selectively provide the one of the first document or the second document include:
one or more instructions to provide the first document,
the information relating to the at least one person including information that is calculated based on information stored in the data structure.

15. A system comprising:
one or more devices to:
receive a search query from a user of a user device;
determine that the search query is a people-related question;
identify, based on determining that the search query is the people-related question and using a data structure, a set of people related to the search query,
the data structure being associated with the user, and
the data structure storing people-related data for a plurality of people with which the user is associated,
the set of people being a subset of the plurality of people;
select at least one person from the set of people;
determine whether to provide information relating to the at least one person; and
selectively provide, to the user device and based on determining whether to provide the information relating to the at least one person, one of:
a first document that identifies the at least one person and provides the information relating to the at least one person,
the information, relating to the at least one person, providing an answer to the people-related question, or
a second document that excludes the information relating to the at least one person.

16. The system of claim 15, where the one or more devices are further to:
obtain information relating to the plurality of people from a plurality of different network-based sources; and
associate, in the data structure, the obtained information with information identifying the plurality of people.

17. The system of claim 16, where the plurality of different network-based sources includes one or more of:
a phone contacts document,
an email account,
a calendar,
a social network,
voice communication records, or
a web site.

18. The system of claim 16, where the obtained information includes, for a person, of the plurality of people, at least one of:
a name of the person,
a nickname of the person,
a tag that identifies a category in which the user has classified the person,
an address of the person,
a phone number of the person,
an email address of the person,
a fax number of the person,
a photo of the person,
information identifying a school that the person is attending or attended,
an occupation of the person,
a birthday of the person, or
a current location of the person.

19. The system of claim 15, where the set of people include a first person and a second person, and
where, when selecting the at least one person, the one or more devices are to:
generate a first score for the first person,
generate a second score for the second person, and
select the at least one person based on the first score and the second score.

20. The system of claim 19, where, when generating the first score and the second score, the one or more devices are further to:
generate the first score and generate the second score based on one or more of:
user-specified categories with which the first person and the second person are associated,
geographic distances between the user and each of the first person and the second person,
indications of how recently the user has interacted with the first person and the second person,
indications of a quantity of interaction the user has had with the first person and a quantity of interactions the user has had with the second person,
authority scores associated with the first person and the second person, or
indications of whether the data structure stores a photo of the first person and the second person.
